(19) United States
(12) Patent Application Publication
(10) Pub. No.: US 2010/0182105 A1
(43) Pub. Date: Jul. 22, 2010

(54) IMPEDANCE-CONTROLLED COPLANAR WAVEGUIDE SYSTEM FOR THE THREE-DIMENSIONAL DISTRIBUTION OF HIGH-BANDWIDTH SIGNALS

(75) Inventors: Matthias Hein, Martinroda (DE); Johannes Trabert, Ilmenau (DE)

Correspondence Address: LUCAS & MERCANTI, LLP, 475 PARK AVENUE SOUTH, 15TH FLOOR, NEW YORK, NY, 10016, US

(73) Assignee: TECHNISCHE UNIVERSITAET ILMENAU, Ilmenau (DE)

(21) Appl. No.: 12/665,366

(22) PCT Filed: Jun. 18, 2008
(86) PCT No.: PCT/EP08/57666

§ 371 Date: Dec. 18, 2009

(30) Foreign Application Priority Data
Jun. 19, 2007 (DE) 10 2007 028 799.4

(51) Int. Cl. H01P 3/12

(52) U.S. Cl. 333/239

(57) ABSTRACT

The invention relates to a waveguide system for distributing high-bandwidth signals in a multilayer circuit carrier. The waveguide system comprises at least one coplanar waveguide (2) and one or more ground wires (3, 4). The coplanar waveguide (2) is disposed with the ground wires (3, 4) associated therewith between at least two insulating layers (5, 6) of the circuit carrier. The surface of the two insulating layers oriented away from the plane of the waveguide (2) has electrically conductive layers (7, 8). Electrically conductive plated through-holes (9, 10) extend along the waveguide (2) substantially perpendicular to the plane of the waveguide. The ground wires (3, 4), the electrically conductive layers (7, 8), and the plated through-holes (9, 10) are electrically connected to ground potential. The waveguide system serves particularly for the three-dimensional distribution of high-bandwidth signals.

The invention concerns an impedance-controlled coplanar waveguide system.

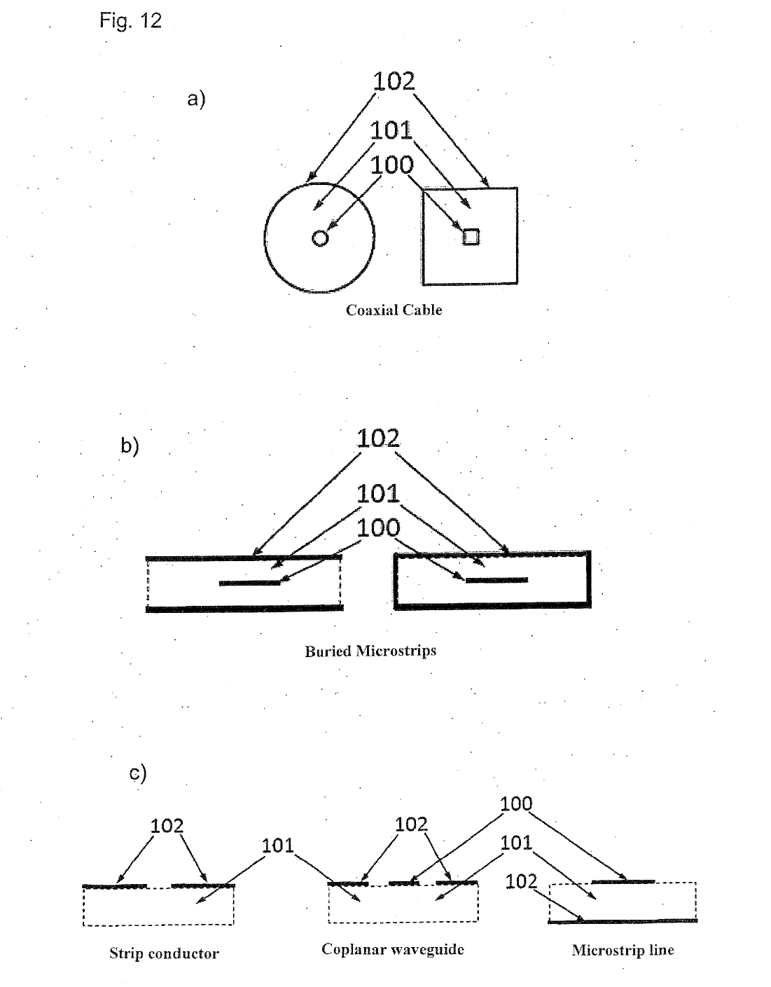

FIG. 12 shows simplified cross-sectional views of commonly used prior-art elementary high-frequency waveguides. FIG. 12(a) shows two typical coaxial cables, in which a central, electrically conductive coaxial conductor 100 is surrounded by a dielectric 101 (insulating layer), and in which an outer electric conductor 102 is provided, which usually acts as a shield.

FIG. 12(b) shows examples of buried microstrips, in which the central conductor 100 has a flat design and is arranged between two ground planes. In this regard, it is possible for several central conductors 100 to run between the ground planes. Buried microstrips of this type are known, for example, by the name “triplate”. Triplate waveguides are preferably used in printed circuits in multilayer technology. The electrically conductive central plane 100 is uniformly spaced from the two parallel ground planes. Similarly to a coaxial cable, this type of design reduces radiation losses. Since the thickness of the dielectric 101 is predetermined by the thickness of the printed circuit board material, the characteristic impedance on a multilevel printed circuit board can be determined by the width of the central conductor 100. However, the impedance (wave resistance of a line to alternating current) depends not only on the spacings of the signal-conducting line but also on the dielectric constant of the surrounding insulating material. Polymer printed circuit boards or multilayer ceramics are usually used for multilayer microwave modules. Their individual layers can be formed in different layer levels.

FIG. 12(c) shows three other previously known designs of high-frequency waveguides, namely, a strip line (left), a coplanar waveguide (middle) and a microstrip line (right).

DE 42 28 349 A1, for example, describes a coplanar waveguide that is suitable for MMIC (monolithic microwave integrated circuit). In order to achieve the lowest possible characteristic impedances, two identical coplanar lines are connected in parallel. Air-gap interfaces are incorporated at the branches of the parallel-connected coplanar lines.

U.S. Pat. No. 6,774,748 B1 discloses a high-frequency unit with a multilayer dielectric substrate, plate through contacts and metallic surfaces. A cavity in which a semiconductor element is mounted is provided between the dielectric layers. The plate through contacts connect the inside of the cavity with the outside.

DE 198 42 800 A1 discloses a surface-mountable casing that can be operated at frequencies in the K band as well as in higher frequency bands. The surface-mountable casing has a dielectric body, which consists essentially of a dielectric substance, a continuous and planar ground conductor, which covers most of the main surface and lateral surfaces of the dielectric body, and a plurality of signal paths in the embodiment of a coplanar line, which are arranged in or on sections of the main surfaces and lateral surfaces that are not covered by the ground conductor.

One problem of the previously known planar waveguides is that they can be optimized only for a limited range of wavelengths. The transmission of very broadband electromagnetic waves is associated with appreciable losses (attenuations) in the unoptimized wavelength ranges. The decreasing wavelength with increasing frequency causes disturbances (inhomogeneities) along the lines to become relatively larger. This leads to greater reflections and thus greater attenuations, i.e., to a weaker available signal at the end of the line. In addition, dispersion effects are produced (dependence of the speed of propagation of the waves on their wavelength) as well as interference effects, which are determined by the fact that additional (undesired) vibrational modes are excited and possibly propagated. The transit time differences of the individual modes result in disturbing, i.e., attenuating, interference effects. The signal energy contained in the unwanted excited modes is practically lost and disturbs neighboring circuit parts due to irradiation, which is a major problem of the previously known lines at higher frequencies.

The general requirements on good broadband signal transmission and good electromagnetic compatibility (EMC) demand exactly defined impedance behavior along the entire signal path (usually constant, e.g., 50 ohms) and later, during manufacture, exact reproducibility for small reflection sources, so-called discontinuities.

One of the objectives of the present invention thus consists in the creation of an impedance-controlled coplanar waveguide system for the three-dimensional, low-loss and shielded distribution of very broadband electromagnetic waves (direct current to microwave signals above 100 GHz, digital signals with very high data rates) in multilayer (at least two layers) circuit carriers.

In addition to this main objective, there are several secondary objectives or goals, including good transmission of higher data rates and signal frequencies and the fulfillment of increasing requirements on better electromagnetic compatibility of corresponding subassemblies.

The objective of the invention is achieved by a waveguide system according to the attached Claim 1.

The impedance-controlled coplanar waveguide system of the invention for the three-dimensional distribution of signals of high bandwidth consists of at least one coplanar waveguide integrated in multilayer circuit carriers. The coplanar waveguide and its associated ground conductors are arranged symmetrically or asymmetrically between at least two continuous or interrupted insulating layers of a multilayer circuit carrier. Associated ground conductors are understood here to be all metal surfaces and plate through contacts (vias) with the same electric potential that surround the signal conductors (waveguides). If the insulating layers have interruptions, the spaces are filled with gases, liquids or vacuum.

The upper side and underside of the multilayer circuit carrier is provided with full-surface or partially closed (perforated/lattice-like) electrically conductive layers. Electrically conductive plate through contacts are provided as electric walls or shields on the other two opposite sides. The ground conductors, the electrically conductive layers and the plate through contacts are peripherally electrically connected. They are all at ground potential and thus form the shield for the waveguide.

A general advantage of the waveguide system of the invention is the lower noise radiation to surrounding circuit components and lines. At the same time, the signal energy that is not radiated is retained as useful energy. In addition, the coupling of (interfering) high-frequency radiation from the outside is improved (interference immunity). Therefore, the electromagnetic compatibility (EMC) of a system of the invention is greatly improved. This has advantageous effects on the achievable component density of the electronic circuits, for the better the EMC aspects of the line design are fulfilled, the smaller the minimum distances to surrounding electronic components can be and the smaller the minimum separations of the lines from one another can be.

In the waveguide system of the invention, the waveguide impedance can be adjusted by the conductor width, the conductor height or conductor shape, by the distance between these conducting coplanar layers, by the relative permittivities of the insulating substrate layers, and/or by the distance from the electrically conductive layers and the plate through contacts.

The insulating layers or dielectrics of the waveguide system of the invention in multilayer circuit carriers can consist of polymeric/organic and/or ceramic/inorganic substrate materials and/or of insulating composite materials and/or foams thereof and/or conductor supports thereof, and of vacuum, air and/or other gases. For example, circuit supports can be individually processed from so-called LTCC ceramic tapes (low-temperature co-fired ceramic), which are flexible in the raw state (print with metal paste, punch out holes for plate through contacts, and fill with metal paste). The layers (up to several tens of them) arc then stacked, pressed together, and sintered at about 900° C. into a compact and hermetically tight block, by which they acquire typical ceramic properties.

The solution according to the present invention has a series of advantages over the previously known high-frequency waveguides. The practically useful frequency range, which is characterized by low losses and mode purity, is increased considerably compared to buried microstrips of the same cross-sectional area. Whereas a useful frequency range of a few tens of GHz is available in triplate structures, the system of the invention now makes significantly more than 100 GHz available with low reflection loss. At the same time, the signal distribution does not have to be, as has been customary until now for high signal frequencies and signal bandwidths, realized in a planar way, i.e., in one plane with single-layer conduction structures that are usually shielded in only one direction, but rather is advantageously realized for miniaturized integration in a multilayer configuration in the third dimension (height) as well. In addition, the solution according to the invention and its embodiments make it possible to realize adjacent and crossed lines that are very well decoupled from one another.

Furthermore, compared to buried microstrips, advantages are obtained with respect to a lesser dependence of the reflection loss (adaptation) of the waveguide on variations of the height of the insulating layers (layer height) and the positioning (offset) of the ground-side plate through contacts surrounding the center signal lines.

In addition to the low-loss wave guidance of broadband signals, the waveguide system of the invention is also suitable for realizing a change in the direction of signal propagation at any desired angles by means of horizontal rotations or waveguide bends. It is likewise possible to bridge any height differences and/or angles of entrance or emergence of the waveguide within a circuit carrier.

Modified embodiments of the invention are fabricated in such a way that they can act as coupling members to conventional waveguides. For example, to this end, an external contact bank of the multilayer circuit carrier can be realized as a microstrip waveguide. The waveguide system is suitable for realizing a single-stage or multistage waveguide transition vertically to the outside and for realizing a waveguide transition laterally to the outside.

Further advantages, details and refinements of the present invention are apparent from the preferred embodiments described below with reference to the drawings.

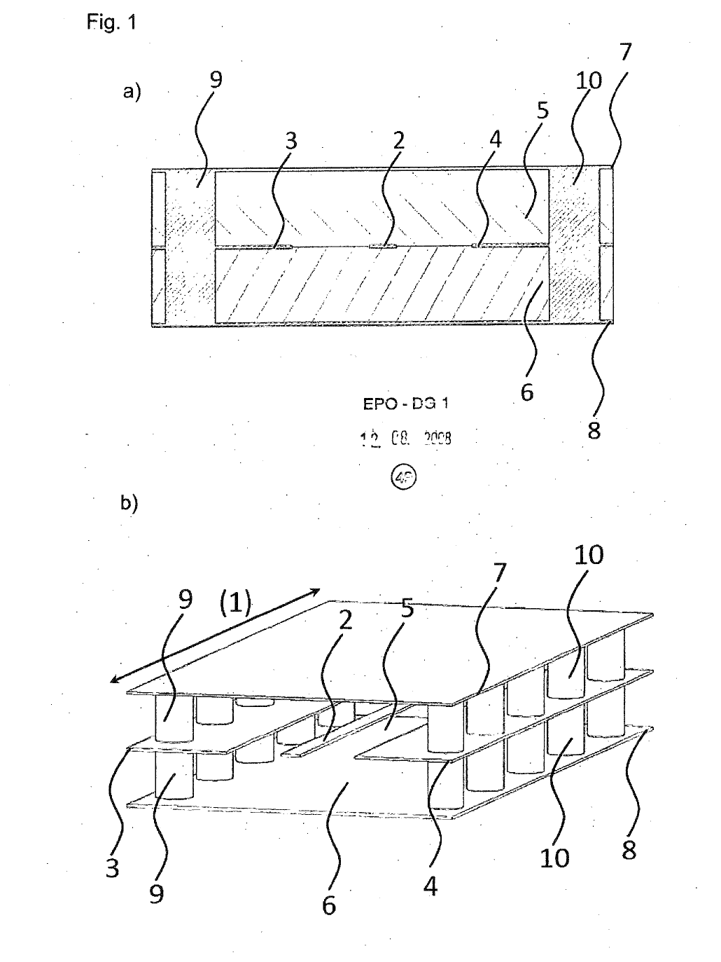

FIG. 1 shows the basic design of a high-frequency waveguide system of the invention in front view and a perspective side view.

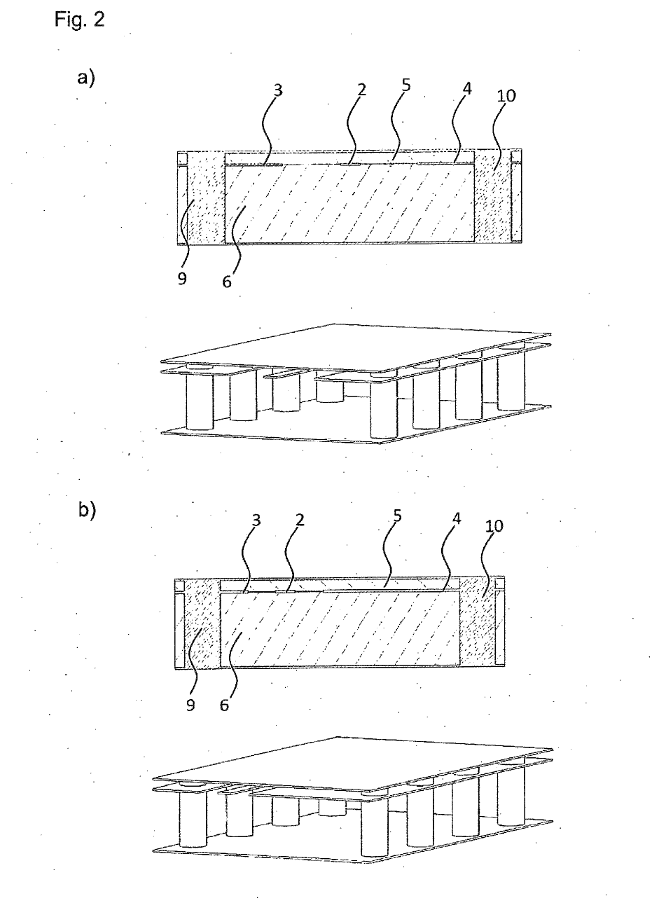

FIG. 2 shows a side view and a perspective view of each of two embodiments of the waveguide system with symmetrical and asymmetrical arrangement of the coplanar waveguides and/or the insulating substrate layers.

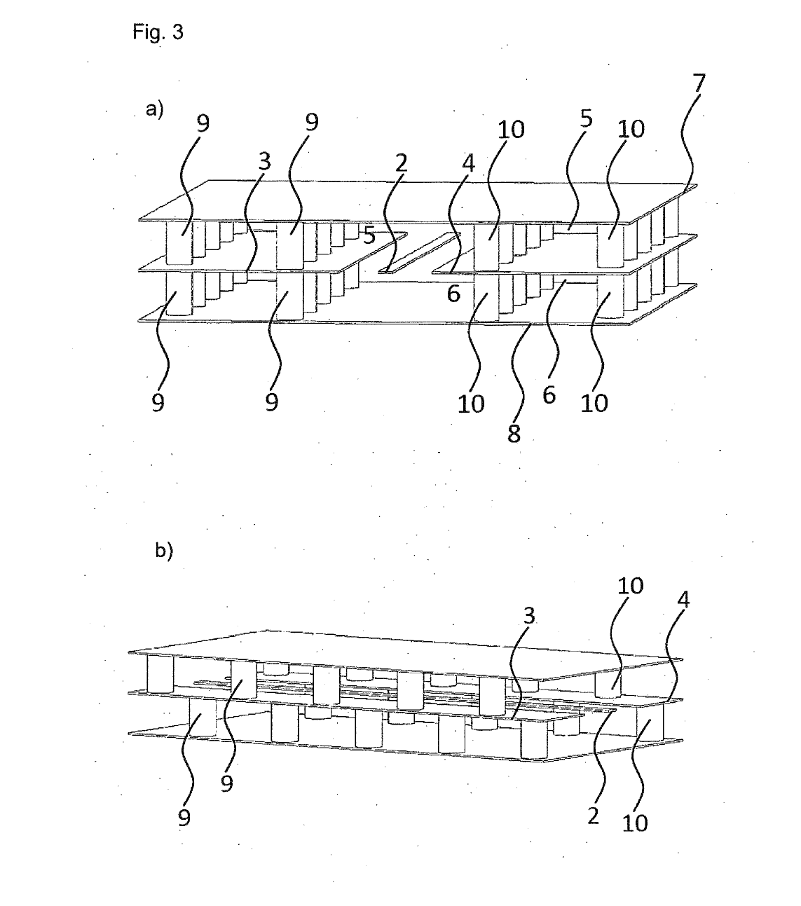

FIG. 3 shows a two-row arrangement and an offset arrangement of plate through contacts of the waveguide system.

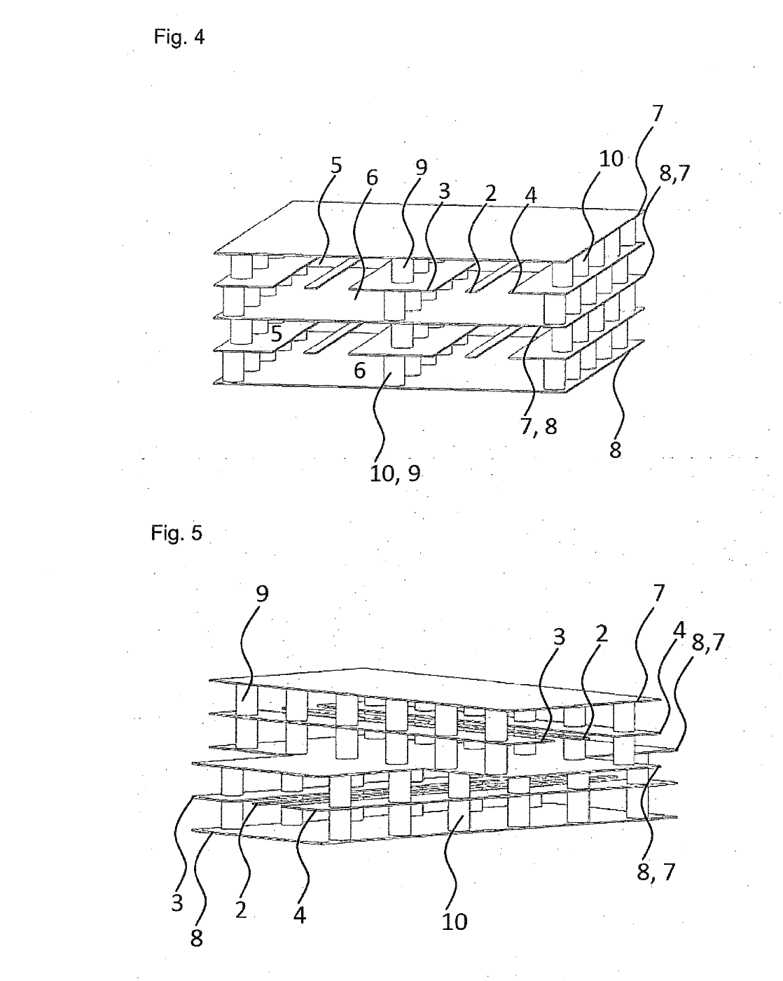

FIG. 4 shows a perspective view of an embodiment with coplanar waveguides arranged in parallel one above the other and side by side.

FIG. 5 shows a perspective view of a crossing of coplanar waveguides lying one above the other.

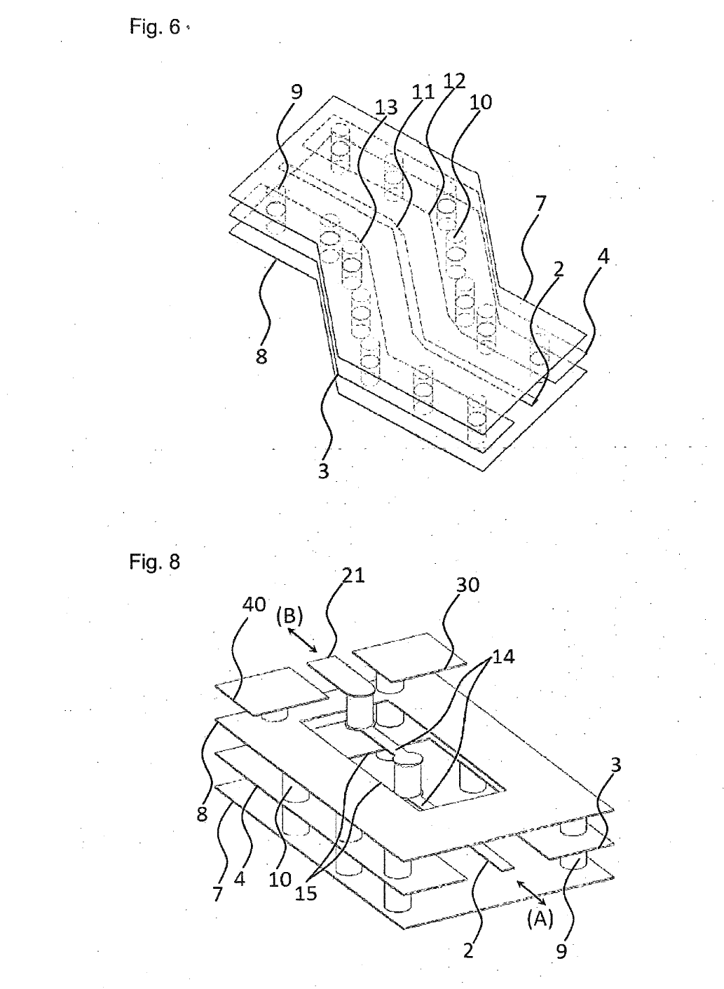

FIG. 6 shows a perspective view of an embodiment of the waveguide system with horizontal rotations or waveguide bends.

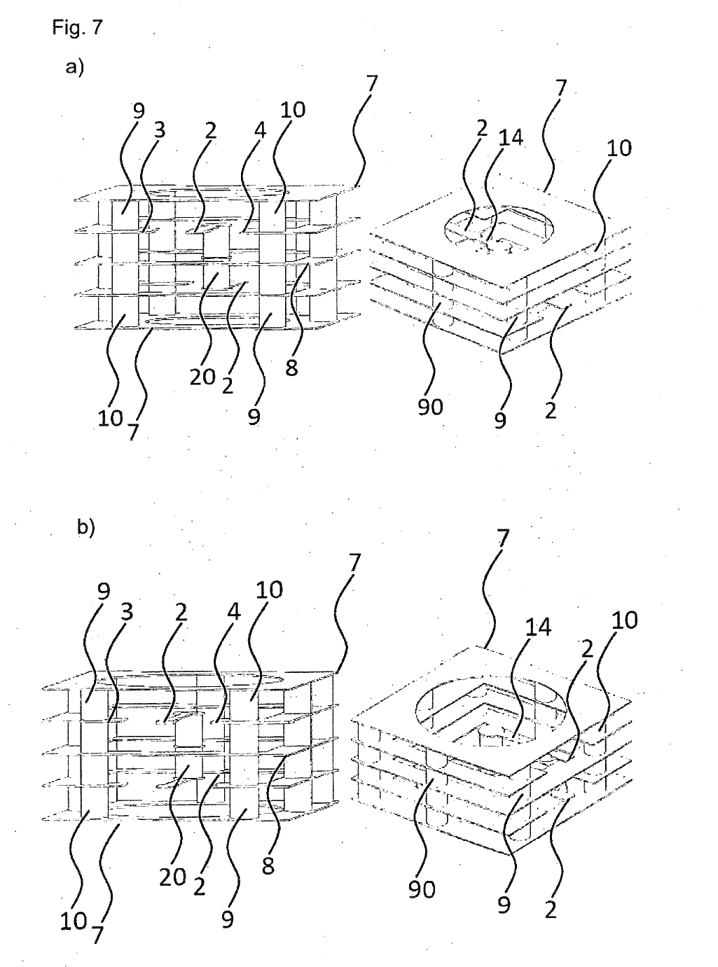

FIG. 7 shows two views of each of two modified embodiments with vertical line transition.

FIG. 8 shows a perspective view of a first embodiment for coupling to previously customary waveguides.

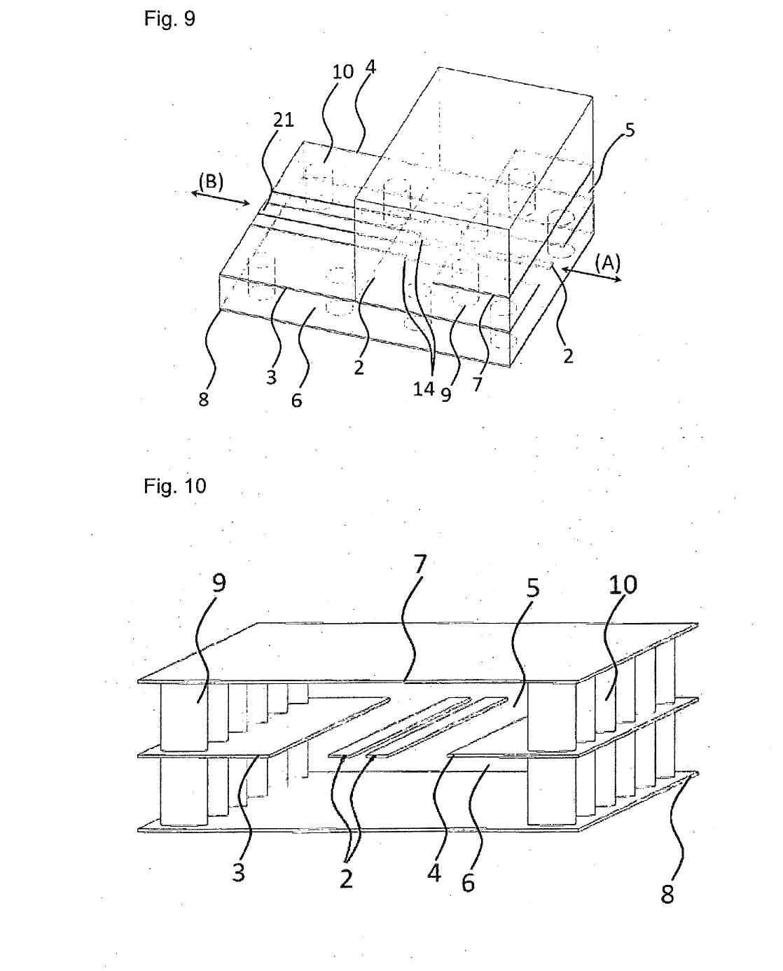

FIG. 9 shows a perspective view of a second embodiment for coupling to previously customary waveguides.

FIG. 10 shows a perspective view of a third embodiment for the transmission of differential signals.

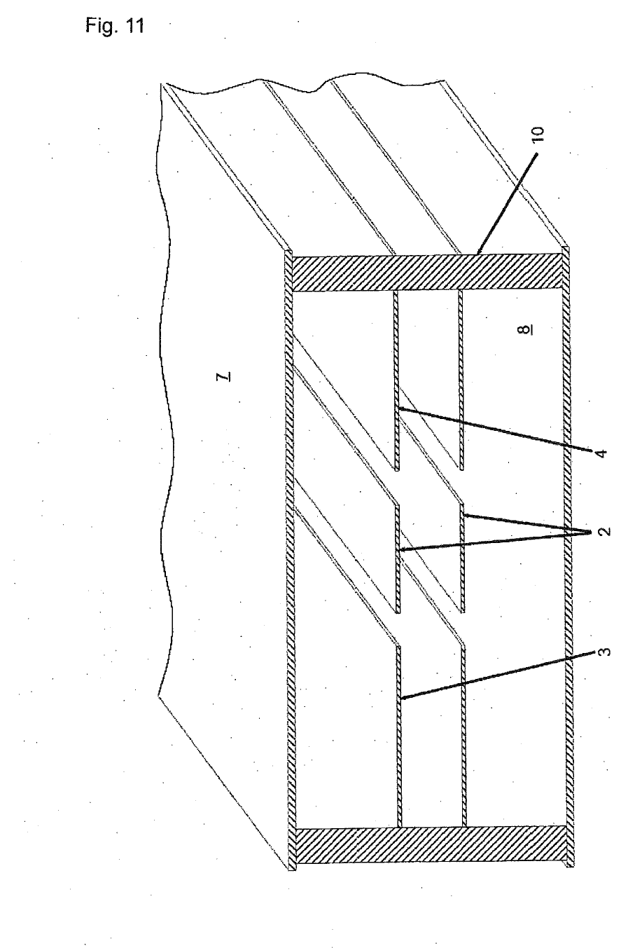

FIG. 11 shows a perspective view of a fourth embodiment for the transmission of differential signals.

FIG. 12 shows cross-sectional views of well-known prior-art high-frequency waveguides.

FIG. 1 shows the basic design of a high-frequency waveguide system of the invention in a front view (FIG. 1(a)) and a perspective side view (FIG. 1(b)). The electromagnetic waves propagate in the direction indicated by the arrow 1, i.e., in the longitudinal direction of the waveguide (in both directions longitudinally) but not transversely to the wiring. The waveguide system consists of an impedance-controlled coplanar waveguide 2 with the associated ground conductors 3, 4, which are both arranged between two dielectric (insulating) substrate layers 5, 6. A surrounding electromagnetic shield is formed with the participation of the ground conductors 3, 4 by shielding layers 7, 8 arranged on the upper side and underside of the circuit carrier and several plate through contacts 9, 10. The plate through contacts 9, 10 extend between the electrically conductive layers on the upper side and underside and are arranged along the coplanar waveguide 2.

The dimensioning specifications for the waveguide and the associated ground conductors are basically well-known to those skilled in the art. In principle, the following rile applies to the arrangement of the plate through contacts: the smaller the separation, the better. In the ideal case, a completely metal-filled electrically conductive shielding wall is obtained, similar to the upper and lower ground plane. However, due to constraints related to production engineering, the plate through contacts are spaced some distance apart, and the vertically remaining space is unmetallized. In practical structures, the distance between the opposite outer surfaces can be about 300 micrometers. The greater this remaining window opening becomes, the poorer the microwave properties become. The appearance of new unwanted wave modes then begins in correspondingly lower frequency ranges. However, this effect is greatly reduced by the ground surfaces guided parallel to the actual (center) signal conductor (waveguide). The main part of the electrical field components is located between the center signal conductor and the coplanar ground planes (symmetrical division right/left). Another field component is present between the neutral conductor and the upper and lower ground planes. Therefore, only one other, very small field component (whose quantification depends on the specific dimensions) can still act at all through the windows or gaps between the plate through contacts. This interfering inverse amplification factor of the electromagnetic field increases with increasing frequency.

Proceeding from this basic design, additional embodiments of the invention are presented in the following figures. These embodiments make it possible to realize a three-dimensional signal distribution within a multilayer circuit carrier (module). The conductor heights, conductor shapes and conductor separations of the coplanar waveguide 2 and the ground conductors 3, 4 themselves and the distance to the surrounding electrically conductive layers of the electromagnetic shielding must be constant along the line in order to achieve constant impedance and minimal dispersion. Therefore, for impedance changes (matching circuit), these geometries (separations, widths and heights) of the line elements and/or the relative permittivities of the insulating substrate layers 5, 6 must be varied along the direction of propagation. This large number of adjustable parameters leads to far more variation possibilities and thus design possibilities for the impedance transformations and more complex matching circuits compared to conventional waveguides.

In this regard as well, those skilled in the art are aware of the rules for constructing the parameters, so that only a few examples for the wide variety of dimensioning will be given here. For example, the dimensioning of the gap between the center signal line (waveguide) and the coplanar ground surfaces on both sides depends essentially on the following parameters:
relative dielectric constant of the insulating material (air=1, LTCC about 8, standard printed circuit board FR4 about 4); the higher the dielectric constant is, the smaller the total line cross section must become (i.e., via separation transversely to the line and layer height must become smaller, and at the same time, the gap between signal conductors and ground surfaces must become larger);
individual layer height of the dielectric; the greater the layer height is, the smaller the gap must become;
metallization thickness; the thicker the metallization is, the larger the gap must become.

In practice, the individual design of a waveguide system prepared by an expert is optimized by subsequent iterative computer simulations. In this regard, the desired impedance is determined by parameter variation with the aid of a so-called 3D EM or full-wave field simulator.

FIGS. 2, 3, 4, and 5 show various embodiments of the solution of the invention. The basic characteristics of these embodiments are briefly described below.

FIG. 2(a), for example, shows a symmetrical arrangement of the coplanar conductors 2, 3, 4 combined with a vertically asymmetrical arrangement of the insulating layers 5, 6 (insulating substrate layers). Other realized circuit functions in a total system can require, e.g., differently high individual layers of the dielectric, which lead to vertical asymmetries of the waveguide structure. However, a smaller distance to the ground plane at the top or bottom requires (local) adaptation to the dimensioning for constant impedance along the line. The gap between the neutral conductor and the coplanar ground plane must, e.g., be somewhat increased. The advantages of the invention (bandwidth, etc.) are then retained.

Other impedances can also be realized in line sections by the specified dimensionings. Impedance jumps of this type, much like the compensation structures described below, are used for better electrical and mechanical adaptations of certain connected components or for filter purposes.

The specified vertical asymmetry can be combined with a horizontal asymmetry. This serves the purpose, e.g., of avoiding other aligned components or realizing line sections of different impedance. Normally, however, both vertical and horizontal symmetry is strived for, since this offers the greatest useful bandwidth.

FIG. 3(a) shows a two-row arrangement of the plate through contacts 9, 10 on both sides of the waveguide 2. FIG. 3(b), on the other hand, illustrates an arrangement of plate through contacts 9, 10 that are vertically offset from one another. Both designs provide better shielding. The (loss) energy emitted in an unwanted way transversely to the direction of signal propagation is reduced. At the same time, the (interference) energy introduced transversely as stray interference by, e.g., neighboring lines, is more strongly damped. Designs of this type, including especially the combination of the variants shown in FIGS. 3(a) and 3(b) (i.e., a two-row offset arrangement), are useful, e.g., when there is a large via separation related to production engineering, in order to keep radiation losses and penetrating interference energies as low as possible. In this connection, an effort is made to design the lateral surface to be as impermeable as possible to microwave energy. Three-row and four-row arrangements are also conceivable, but less and less additional shielding effect can be achieved in this way.

FIG. 4 shows a perspective view of coplanar waveguides arranged in parallel one above the other and side by side. This illustrates the great variety of possible combinations for the arrangement of the waveguides. The individual levels of the multilayer circuit carrier are separated by at least one shielding layer 7 if the waveguide 2 is not intended to change between the levels (see below, modified embodiments). The electrically conductive shielding layers thus run as separating planes between the individual levels, i.e., the shielding layers extend essentially parallel to the plane of the waveguide 2, in each case on the surface of the dielectric substrate or insulating layers 5, 6 that faces away from this plane. In the case of multilevel circuit carriers, the plate through contacts preferably extend between the shielding layers 7 and ground conductors 3, 4, but, if necessary, they can also run through the ground conductors.

FIG. 5 shows a crossing of coplanar waveguides that lie one above the other. The flat shielding layers 7, 8 effectively shield the crosswise-running waveguides 2 from each other.

FIG. 6 illustrates a further modified embodiment with horizontal rotations or line bends of the waveguide 2 and the associated ground conductors 3, 4. These types of changes in direction serve to change the direction of signal propagation. Integrated compensation systems, such as a geometrically defined narrowing 11 and/or corresponding widenings of the signal conductor 2, can be provided for reducing locally excessive capacitance. The expert is basically already familiar with the dimensioning of the compensation system for frequency response correction. Local impedance differences (relative to the nominal characteristic impedance of the high-frequency line) are compensated by well-defined outward and/or inward shifting 12, 13 of the coplanar ground layers 3, 4 in such a way that only minimal reflections of the transmitted signals occur in this place.

FIG. 7 shows embodiments with which any height differences and angles of entrance or emergence can be realized with the aid of a coaxial waveguide structure connected perpendicularly to the direction of signal propagation. In this regard, FIG. 7(a) shows two views of an example of vertical line transition between two different and equally high conduction planes without rotation. The direction of propagation of the waveguides 2 in the different planes remains unchanged in this case. The change of planes occurs with the aid of central waveguide plate through contacts 20, which extend between the waveguides 2. The waveguide plate through contacts 20 extend through openings in the shielding layers 7, 8.

FIG. 7(b) shows in two additional views a vertical line transition between two different and equally high conduction planes with simultaneous 180° rotation of the direction of wave propagation and corresponding compensation systems with defined line narrowing (cf. FIG. 6). In addition, recesses 21 are provided on the ground surfaces that lie opposite the end faces of the signal plate through contacts. These recesses serve to compensate or reduce the increased capacitance that occurs there. In the example shown here, the recesses 21 are circular, but they can also have a square shape or any other desired shape.

The waveguide transitions shown in FIGS. 8 and 9 provide for compatibility of the waveguide system of the invention with previously customary waveguides.

For example, FIG. 8 shows a buried line arrangement of a single-stage or multistage (offset horizontally to the direction of propagation) waveguide transition (A), e.g., from the inside of a microwave module, vertically towards the outside (B) to, for example, integrated bare chips (dice)/first-level interconnection or vice versa into a ground-signal conductor-ground contacting structure. Integrated compensation systems 14 are realized by narrowings and/or widenings of the center signal line 2 that are geometrically well defined in length and width and/or by such narrowings and/or widenings of the coplanar surrounding ground surfaces 3, 4 and by indentations or overlappings of the ground surface that lies above the center signal layer. Openings 15 of the end faces of the ground surfaces serve the purpose of well-defined reduction of the excessive capacitance at the end faces of the plate through contacts of the center signal line 2 and can have any desired shapes (square in the present case). They compensate local impedance differences (relative to the nominal characteristic impedance of the high-frequency line) in such a way that only minimal reflections of the signals to be transmitted occur in this place.

FIG. 9 shows a waveguide transition (e.g., from the inside of a microwave module (A), laterally towards the outside (B) to the peripheral electronics/“second-level interconnection” or vice versa into a ground-signal conductor-ground structure. Integrated compensation systems 14 are realized by narrowings and/or widenings of the center signal line 2 that are geometrically well defined in length and width and/or by such narrowings and/or widenings of the coplanar surrounding ground surfaces 3, 4. Indentations or overlappings of the ground surface 7 that lies above the center signal layer and overlappings of the insulating substrate layers 5 inside the module compensate local impedance differences (relative to the nominal characteristic impedance of the high-frequency line) in such a way that only minimal reflections of the transmitted signals occur in this place.

FIG. 10 shows, instead of a single signal conductor, two coplanar waveguides 2 that are parallel and coupled with each other for transmitting electromagnetic waves. The basic structure of the coplanar waveguide system of the invention shown in FIG. 1 can also be used for this embodiment. In general, waveguides can also be designed as a differential, i.e., antiphase, pair of lines. The relevant electric field component in this case is concentrated between the two conductors. In this regard, the differential impedance is different; it is usually higher than in the case of a single signal conductor relative to the nominal or basic impedance of the waveguide.

For example, two-wire flat strip lines have long been known, which were used in older radio receivers as inexpensive antenna cable with characteristic impedances in the range of 120-300 ohms, e.g., as so-called “VHF strip line” with polyethylene as dielectric but without external shielding. On the model of this concept, an additional signal line is supplied in the cross section of the waveguide described above in order to realize differential signal transmission.

The embodiment shown in FIG. 10 represents a waveguide system with two signal lines 2, which lie parallel alongside each other, are spaced a well-defined distance apart, and are surrounded on both sides by ground surfaces 3, 4 that have a coplanar arrangement and are spaced a well-defined distance apart. The relevant electric field component is concentrated (with respect to the drawing) horizontally between the two conductors. The ground surfaces on the upper side and underside and the plate through contacts 10 bounding the structure on the right and left conform to the system in FIG. 1.

The embodiment shown in FIG. 11 likewise has a double signal line 2 necessary for differential supply. However, in contrast to the embodiment according to FIG. 10, the waveguides 2 are arranged one above the other. In this system, the relevant electric field component is concentrated (with respect to the drawing) vertically between the two center signal conductors 2. The expert is likewise familiar with appropriate dimensioning methods and the use of suitable simulation software for this.

However, the embodiments shown in FIGS. 10 and 11 can also be used for now standard digital signals, which are transmitted, e.g., in computer networks by miniaturized two-wire line in twisted form in the network cable or parallel-conducted on a printed circuit board integrated in the device. The idea of the invention of a coplanar waveguide structure with surrounding shielding can thus also be transferred to these kinds of differential line types, where the concept on which this specification is based refers to the local-mode signal distribution concentrated in the circuit carrier and not to “novel” cables. Therefore, for these areas of application as well, the invention improves the features of the signal distribution (with respect to bandwidth, reflections, attenuation, dispersion) and reduces noise radiation and the coupling of interfering radiation (interference immunity).

For three-dimensional differential signal transmission, the two waveguide systems illustrated in FIGS. 10 and 11 are supplemented by the special design concepts illustrated in FIGS. 5 to 9, where double signal conductors arranged in parallel are used instead of the single center signal line (according to FIG. 1). In these systems, the plane of symmetry is positioned centrally between the two signal conductors, i.e., a vertical plane of symmetry in the embodiment according to FIG. 10 and a horizontal plane of symmetry in the embodiment according to FIG. 11.

Therefore, especially differential vertical transitions according to FIGS. 7 and 8 require two parallel signal plate through contacts that lie side by side or opposite each other. In addition, as shown in FIG. 6, it is possible to realize L-shaped and Y-shaped line bends of both signal conductors or line branchings, i.e., separation of the two signal conductors and respective transition of the differential wave mode into the “ground-signal-ground” basic mode (according to FIG. 1).

Analogously, at the respective transition and bending points (discontinuities), it is possible, for frequency response correction, to use the variants of compensation systems that have already been described in the case of the single-signal conductor system (cf. FIG. 6: reference numbers 11, 12, 13; FIG. 8: reference numbers 14, 15; FIG. 9: reference numbers 14, 7).

### LIST OF REFERENCE NUMBERS

1 direction of propagation of the electromagnetic waves
2 coplanar waveguide
3, 4 ground conductors
5, 6 dielectric substrate layers
7, 8 shielding layers
9, 10 plate through contact
11 narrowing of the waveguide
12, 13 shift points of the ground conductors
14 compensation system
15 opening
20 waveguide plate through contacts
21 recesses

1-13. (canceled)

14. A waveguide system for distribution of signals of high bandwidth in a multilayer circuit carrier, comprising: at least one coplanar waveguide; ground conductors associated with the coplanar waveguide; dielectric insulating layers, the coplanar waveguide with its associated ground conductors being arranged between at least two of the insulating layers, the two insulating layers having surfaces that face away from a plane of the waveguide and are provided with electrically conductive layers; and electrically conductive plate through contacts arranged along the waveguide so as to extend essentially perpendicularly to the plane of the waveguide, the ground conductors, the electrically conductive layers, and the plate through contacts being electrically connected to ground potential.

15. The waveguide system in accordance with claim 14, wherein the waveguide system is operative to provide a three-dimensional distribution of signals of high bandwidth.

16. The waveguide system in accordance with claim 14, wherein the insulating layers are substrate layers that are interrupted in certain sectors to form spaces, the spaces being filled with gases, liquids or vacuum.

17. The waveguide system in accordance with claim 14, wherein the waveguide is arranged asymmetrically between the ground conductors and/or asymmetrically between the insulating layers.

18. The waveguide system in accordance with claim 14, wherein the electrically conductive layers are only partially closed.

19. The waveguide system in accordance with claim 18, wherein the electrically conductive layers are perforated.

20. The waveguide system in accordance with claim 18, wherein the electrically conductive layers are lattice-like.

21. The waveguide system in accordance with claim 14, wherein waveguide impedance is adjustable by conductor width, conductor height or conductor shape of the waveguide and/or of the ground conductors, by a distance between the ground conductors, by relative permittivities of the insulating layers, and/or by a distance of the conductors from the electrically conductive layers and the plate through contacts.

22. The waveguide system in accordance with claim 14, having two coplanar waveguides that are parallel and coupled with each other for transmitting electromagnetic waves.

23. The waveguide system in accordance with claim 14, having a plurality of coplanar waveguides, the coplanar waveguides and their associated ground conductors being arranged in several levels above one another and/or side by side with parallel offset or crossed at any desired angle, where waveguides lying in a plane are shielded from one another by plate through contacts, while the waveguides extending in different levels are shielded from one another by the electrically conductive layers.

24. The waveguide system in accordance with claim 23, wherein the waveguide of a first level is electrically connected with the waveguide of a second level by a waveguide plate through contact, wherein the waveguide plate through contact extends through an opening in the intermediate electrically conductive layer, which is electrically connected to ground potential, but the waveguide plate through contact itself is not connected to ground potential.

25. The waveguide system in accordance with claim 24, wherein a recess is provided in the electrically conductive layer opposite an end face of the conductor plate through contact in the electrically conductive layer, which is connected to ground potential, to compensate capacitance change in the end face.

26. The waveguide system in accordance with claim 24, wherein the waveguides, which run in different levels and are electrically connected with one another, run at angles to one another or opposite one another, to realize a change in a direction of signal propagation.

27. The waveguide system in accordance with claim 14, wherein the plate through contacts have any desired cross section and are arranged in single parallel or multiple parallel rows.

28. The waveguide system in accordance with claim 14, wherein an external contact bank of the multilayer circuit carrier is a microstrip waveguide.
